(19) United States
(12) Patent Application Publication
(10) Pub. No.: US 2008/0263922 A1
(43) Pub. Date: Oct. 30, 2008

(54) CUSTOMIZABLE FLOOR MATS AND VERTICAL DISPLAYS

(76) Inventors: Stanley Ho, Warren, NJ (US); Jim Ashley, Rock Hill, SC (US)

Correspondence Address: FROMMER LAWRENCE & HAUG, 745 FIFTH AVENUE- 10TH FL., NEW YORK, NY, 10151, US

(21) Appl. No.: 12/111,003

(22) Filed: Apr. 28, 2008

Related U.S. Application Data
(60) Provisional application No. 60/914,229, filed on Apr. 26, 2007.

(51) Int. Cl. G09F 11/30; B32B 3/06

(52) U.S. Cl. 40/508; 428/99

(57) ABSTRACT

A floor mat or vertical display having a main section and an insert section. The main section includes a shaped space for accommodating the insert section, such that the appearance of the mat or display can be customized by selecting the insert section that is placed into the shaped space.

### INCORPORATION BY REFERENCE

This application is based upon and claims the benefit of priority from the U.S. patent application No. 10/976,722, filed Oct. 27, 2004, and U.S. Provisional Patent Application No. 60/914,229, filed Apr. 26, 2007, the entire contents of which are incorporated herein by reference.

### FIELD OF THE INVENTION

The present invention relates to floor mats, area rugs, and vertically mounted exhibits; and more particularly to a floor mat, area rug or vertically mounted exhibit having an insert section that is incorporated into the article.

### BACKGROUND OF THE INVENTION

Various types of mats and area rugs (collectively referred to hereinafter as “floor mats”) are a common feature around homes and other types of buildings. A typical building owner will purchase a “welcome mat” for use just outside the main entrance of a building, an indoor mat for use just inside the entrance, and one or more area rugs for use in decorating and protecting open floor areas. Furthermore, the building owner will frequently purchase replacement mats when current mats wear out. This is particularly true of welcome mats, which tend to wear out faster than indoor mats and rugs since they are exposed to the elements and since people arriving at the entrance where they are placed use them to clean off their shoes prior to entering the building.

Floor mats have also been used to mark special occasions and changes of season, and to advertise products and services. For example, many homeowners will mark the Christmas holiday by using a welcome mat that depicts a Christmas scene such as a snowman or Santa Claus. Still further, some building owners have begun to employ customized floor mats, such as a welcome mat bearing the street number of the building for which it is used, or a welcome mat bearing the name of a sponsor.

Homeowners and building owners also make frequent use of flat wall mounted displays for purposes of decorating open wall areas, marking special occasions and changes of season. Owners of commercial buildings also use such displays for advertising products and services.

In view of the multiplying uses of floor mats and vertical displays, many building owners find themselves buying a large number of such articles, and find themselves frequently going through the process of storing or disposing of a currently used mats and displays and deploying different ones.

### SUMMARY OF THE INVENTION

The inventor of the present invention has noted the expanding practice of using a multiple of interchangeable floor mats and vertical displays and has recognized the desirability of providing floor mats and displays with a customizable appearance. Accordingly, the present invention provides a floor mat or vertical display having a main section and an insert section, wherein the main section includes a shaped space for accommodating the insert section, such that the appearance of the mat or display can be customized by selecting the insert section that is placed into the shaped space.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 shows a main section and insert section in accordance with the present invention;

FIG. 2 shows the floor mat of FIG. 1 with the insert section positioned within the main section;

FIG. 3 shows the floor mat of FIG. 2 with a different insert section positioned within the main section; and

FIG. 4 shows an illustrative embodiment of a vertically mounted display in accordance with the present invention.

FIG. 5 shows the floor mat of FIG. 1 wherein the insert contains a switch and circuitry means for emitting an audible signal.

FIG. 6 shows the floor mat of FIG. 1 wherein the shaped space and insert have an attaching means.

### DETAILED DESCRIPTION

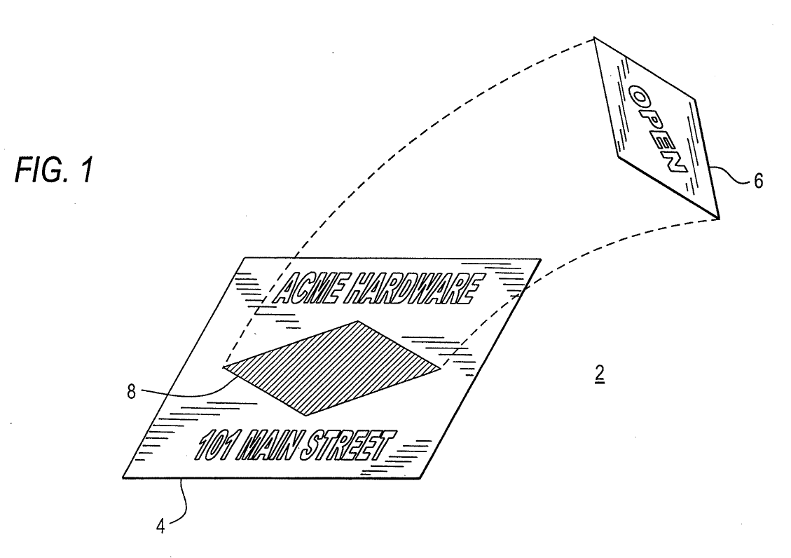

Referring to FIG. 1, there is shown a floor mat 2 in accordance with the present invention. The floor mat can be of a dimension or size suitable for placement in front of, or just inside, a door, for either commercial or residential use or can be used either indoor or outdoor. For instance, the floor mat can be of a dimension of 20″×30″, 22″×34″, 2′×3′, 3′×5′, 3′×10′, 3′×20′, 4′×6′, 4′×20′ or other suitable dimensions.

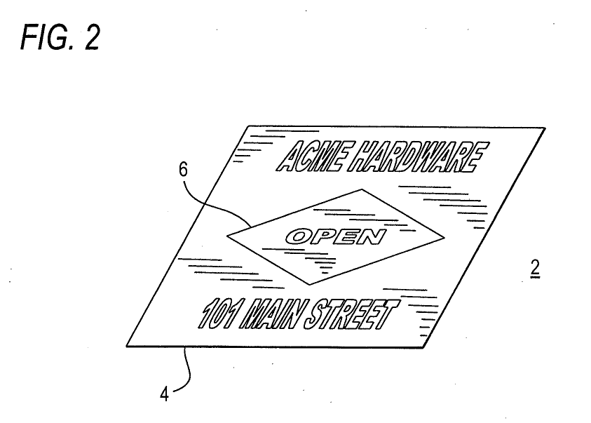

The floor mat is made up of a main section 4 and an insert section 6. The insert section 6 can have a first side and a second side, or an upper side and a lower side. The main section includes a shaped space 8 for accommodating the insert section such that when the insert section is inserted into the shaped space the mat appears as one shown in FIG. 2. For instance, the second side or lower side can be placed into the shaped space facing downwards and allowing the first side or upper side to be visible. The shaped space 8 can be recessed into the main section 4. The insert section 6 can be of a height dimension equal to that of recession of the shaped space 8 in the main section 4, such that when the insert section 6 is placed into the recessed, shaped space 8, the insert section 6 and the main section 4 have a continuous profile. Alternatively, the insert section 6 can have a height dimension less then or greater than the recession of the shaped space 8, such that when the insert section 6 is placed into the recessed, shaped space 8 the insert section 6 and the main section 4 do not have a continuous profile. In one embodiment, the main section 4 completely surrounds the insert section 6 along the periphery of the insert section 6.

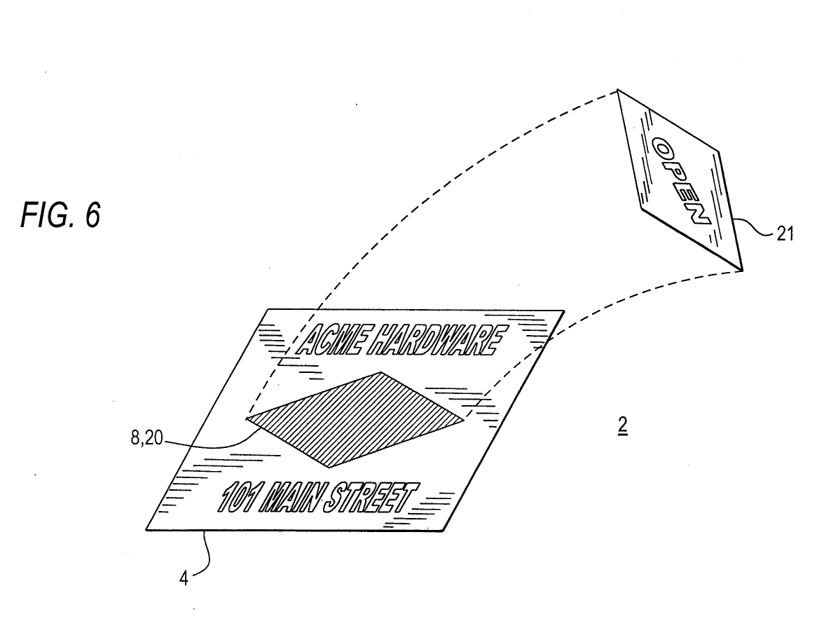

The insert section 6 is secured within the shaped space 8 using any number of alternative techniques using a variety of attachment materials. One way to removably affix the insert section to the main section is through the use of a VELCRO fastening system. That is, with reference to FIG. 6, a VELCRO hook section could be applied to the shaped space 20 while a VELCRO loop section is applied to the back of the insert section 21 such that the hook and loop sections can hold together the mat sections. An alternative is to apply a loop section to the shaped space and a hook section to the insert section 21.

Other ways for removably affixing the mat sections to one another include the use of a magnetic coupling, a repositionable adhesive, electrostatic forces, mechanical interlocks, and the use of a snap-fit arrangement at 20, 21. Other means for securing the insert section to the main section of the mat would be obvious to one skilled in the art. Still further, the insert section may be simply placed in the shaped space and held in place by nothing more than its own weight.

When relying on more than the weight of the insert section alone to removably affix the insert section to the main section of the floor mat, it may be desirable to alter the strength of the affixing arrangement employed. For example, a large insert section placed in a high traffic area of the mat may require a stronger attachment than a small insert placed in an area subject to a lower level of traffic. Or, as another example, an insert section completely surrounded by the main section of the mat may require a lesser attachment than an insert with a periphery that forms part of the periphery of the assembled mat. It would be obvious to one of ordinary skill in the art to recognize that other situations would require either a greater or a lesser attachment to provide an appropriately durable floor mat.

In order to modify the strength of attachment for the insert section, the arrangement of the attachment means may be modified to produce the desired attachment. For example, an aggressive attachment could be achieved by applying the affixing material to the entire, or substantially entire, interface surface of the insert section and the portion of the main section of the mat that receives the insert section (i.e., the shaped space). For example, if a hook and loop fastener system, such as VELCRO, is used, a maximum degree of attachment would be achieved if one of the coacting components of the VELCRO, i.e. either the hook or the loop component, fully covered the interface surface of the insert and the appropriate mating component, i.e. either the loop or the hook component, fully covered the shaped space on the main section of the mat adapted to accept the insert section. A lesser degree of attachment would be achieved if one surface had less than full coverage of one of the coacting components, while the second surface was fully covered by the other component. For example, if the shaped space in the floor mat had full coverage of the hook component and the appropriately configured insert had 50% coverage of the loop component, the strength of attachment would be approximately half of that achieved if both surfaces were fully covered with the appropriate hook and loop components. The less than full coverage could be achieved by arranging one or both components of the attachment system in a fixed pattern, a random pattern, or by any other method known in the art. A similar result would be achieved if the shaped space for the insert and the appropriate surface of the insert had corresponding patterns of attachment components. For example, a shaped space and insert which are both rectangular could have attachment means placed in the corners, and/or in the center and/or in lines traversing all or a portion of the shaped space and insert. The placement of attaching means on a shaped space and corresponding insert of other shapes can be similarly configured. Possible arrangements of the attaching means within the scope of the present invention include the edges of the insert section and shaped space, the corners of the insert section and shaped space, one or more lines at least partially traversing the insert section and shaped space, and one or more shapes, including circles, squares, rectangles, and ovals.

In one embodiment of the invention, the insert section 6 is reversible, such that each of the first and second sides, or each of the upper and lower sides can have attaching means as described herein. The insert section 6 can therefore be reversibly placed in the shaped space 8, such that the insert section 6 is removably affixed regardless of whether the first or second side or the upper or lower side are downwards facing. Alternatively, the attaching means can be pleased only on a single side of the insert section 6, for example the second or lower side.

One way to permanently affix the mat sections to one another is through the use of a permanent adhesive at 20, 21. Another way to permanently affix the sections is through a locking snap-fit.

Of course, any combination of the above techniques may be used to secure the mat sections, and additional techniques for securing the mat sections will be apparent to one skilled in the art of the invention upon reading this description.

In one embodiment of the present invention, the insert section can contain one or more indicia on one or more of the first or second sides or the upper or lower sides.

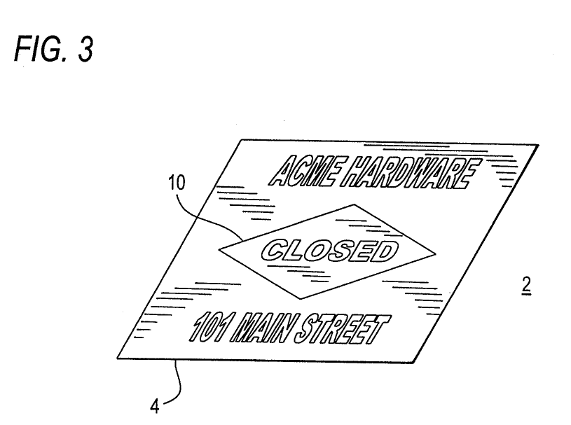

In any event, it is noted that in one embodiment, the floor mat depicted in FIGS. 1 and 2 is designed for use at a store front and serves to indicate when the store is open for business. Accordingly, the insert section 6 is detachable affixed and bears the word “OPEN.” When the store is closed, the mat is employed as shown in FIG. 3. In FIG. 3, the insert section 6 bearing the word “OPEN” has been removed and an insert section 10 bearing the word “CLOSED” is inserted into the shaped space. In this manner the store using the mat, “Acme Hardware,” can employ a customized main section bearing its name and address, “Acme Hardware—101 Main Street,” and can insert the appropriate section to indicate when they are open or closed. Further, the insert sections are positioned at the parts of the mat that wear down quickest, allowing for a worn insert section to be replaced with a new insert section to improve the overall condition of the mat without having to replace the main section.

It is important to note that the “OPEN” and “CLOSED” messages are only examples of the messages that can be displayed using the invention. Alternative messages that may be displayed include advertising messages indicative of a particular product or slogan, seasonal messages that can be changed to correspond with the current season, and holiday messages such as Merry Christmas. Of course, the term “messages” is not limited to written messages, but rather, includes pictorial messages.

In one embodiment, is preferably, the insert section 6 is made of the same material or similar material as the main section 4. Furthermore, it the insert section is placed and secured in the shaped space 8 such that the mat gives a uniform or seamless appearance. In other words, unless there was a close inspection, there would not appear any visible signs of demarcation or separation between the insert section and main section.

Another embodiment of the present invention provides a method for producing a floor mat with removable and customizable insert section. According one embodiment of this method, a selection is made. Typically, a person such as a customer, but not necessarily, selects one or more sections to be removed from a whole one-piece mat. The selecting person can choose the size, shape, and other characteristics of the section to be removed. These removed sections would then form the insert sections of the current invention. After the insert sections are removed, such as by cutting, slicing, separating, or any other sufficient method, they can further be modified according to the user or customer's preferences. One preferred modification would be to affix any sort of graphics or indicia to the one or more sides of the removed insert sections. Other modifications could include further include changing the size, shape, width, thickness, area, or other physical and visual characteristics of the one or more insert sections. Ideally, a customer would want the insert section to be symmetrical such that when the insert section is on either its front or back so that it could fit into the shaped space. Then the insert sections could have a different customizable appearance on its front and back and be used in the mat.

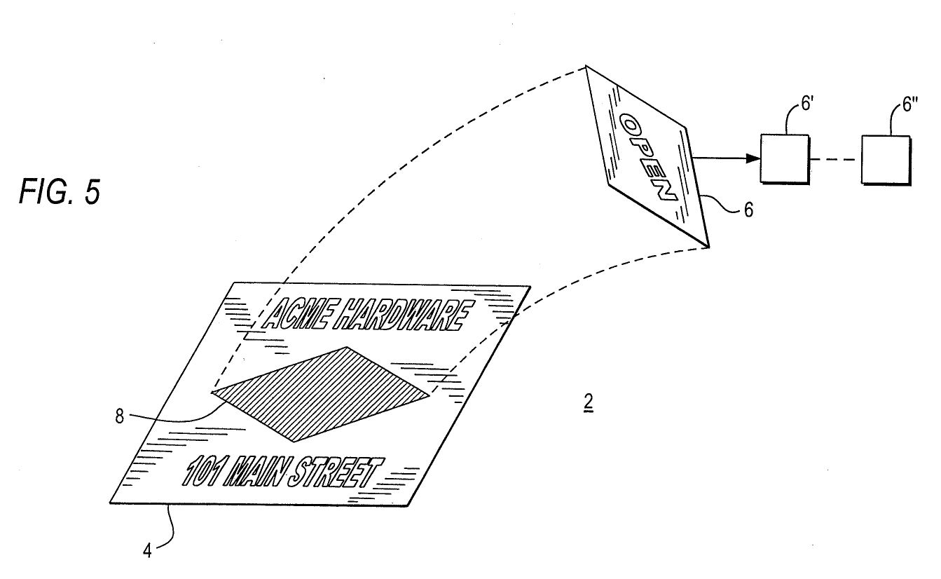

As an added feature, with reference to FIG. 5, the floor mats of the invention may include an electronic switch 6′ and sound generation circuitry 6″ for the purpose of triggering the playing of a musical greeting or other audible signal, such as a pre-recorded voice greeting. For instance, an insert section depicting a Christmas scene my include a switch and sound generation circuitry for playing the tune “Jingle Bells.” Alternatively, a welcome mat of the invention may include a switch for triggering the door bell associated with the door where the mat is placed.

Having thus described an illustrative embodiment of the present invention, it is to be understood that the invention is not limited to particular details set forth in the above description as many apparent variations thereof are possible without departing from the spirit or scope of the present invention. For example, the main section and insert sections can bear any combination of words and/or designs, the shaped space of the main section can be of any shape, such as circular, rectangular, triangular or irregular, and there may be more than one shaped space on a main section. Also, the main section need not completely surround the insert section at the periphery of the insert section, but rather, the periphery of the insert section may make up at least part of the periphery of the assembled mat.

One particular alternative embodiment is a vertically mounted implementation of the invention. In such an embodiment an article similar to the mat depicted in FIGS. 1-3, having a main section and insert section, is mounted on a wall, or suspended from a wall or ceiling. Indeed, the invention may be implemented in a dual purpose article that can be used either as a floor mat or vertical exhibit. In any case, all of the features discussed in connection with the floor mat embodiments are applicable to the vertical exhibit embodiments.

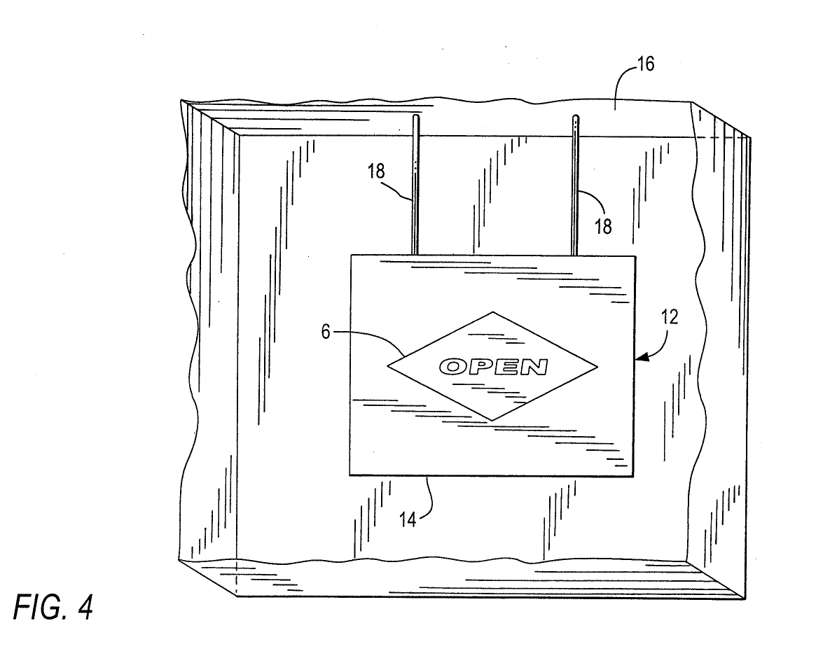

FIG. 4 shows an illustrative embodiment of a vertically mounted display in accordance with the invention. The vertical display 12 includes a main section 14 that is configured for hanging from ceiling 16 via supports 18. In this embodiment, the display uses the same insert 6 as used in the FIG. 1 and 2 embodiments, although any of the contemplated alternative inserts may be employed.

It is to be understood that the invention defined by the appended claims is not to be limited to particular details set forth in the above description as many apparent variations thereof are possible without departing from the spirit or scope of the present invention

What is claimed is:

1. A floor mat, comprising a main section and an insert section, wherein the main section includes a shaped space for accommodating the insert section, such that the appearance of the mat can be customized by selecting the insert section that is placed into the shaped space.

2. The floor mat as described in paragraph 1, wherein the insert section is removably affixed to the main section.

3. The floor mat as described in paragraph 1, wherein the insert section is permanently affixed to the main section.

4. The floor mat as described in paragraph 1, wherein the main section completely surrounds the insert section at the periphery of the insert section.

5. The floor mat as described in paragraph 1, wherein the main section does not completely surround the insert section at the periphery of the insert section.

6. The floor mat as described in paragraph 1, wherein the insert section includes a switch for triggering the generation of an audible signal.

7. A vertically mounted exhibit, comprising a main section and an insert section, wherein the main section includes a shaped space for accommodating the insert section, such that the appearance of the exhibit can be customized by selecting the insert section that is placed into the shaped space.

8. The exhibit as described in paragraph 7, wherein the insert section is removably affixed to the main section.

9. The exhibit as described in paragraph 7, wherein the insert section is permanently affixed to the main section.

10. The exhibit as described in paragraph 7, wherein the main section completely surrounds the insert section at the periphery of the insert section.

11. The exhibit as described in paragraph 7, wherein the main section does not completely surround the insert section at the periphery of the insert section.

12. A method of providing messages, comprising the steps of providing a generally flat article having a main section and an insert section, wherein the main section includes a shaped space for accommodating the insert section and the insert section bears a message changing the insert section to an insert section bearing a new message that is desired to be currently transmitted.

13. The floor mat of paragraph 2, wherein the insert section is removably affixed to the main section by means of hook and loop fasteners, repositionable adhesive, magnetic coupling or mechanical interlocks.

14. The floor mat of paragraph 13, wherein the means of removably affixing the insert section to the main section covers the entire insert section and the entire area of a shaped space on the main section that receives the insert section.

15. The floor mat of paragraph 13, wherein the means of removably affixing the insert section to the main section covers a portion of the insert section and a portion of a shaped space on the main section that receives the insert section.

16. The floor mat of paragraph 15, wherein the means of removably affixing the insert section to the main section is present on the insert section and a shaped space on the main section in a pattern formation.

17. The floor mat of paragraph 15, wherein the pattern formation comprises one or more of: the edges of the insert section and shaped space, the corners of the insert section and shaped space, one or more lines at least partially traversing the insert section and shaped space, and one or more shapes, including circles, squares, rectangles, and ovals.
